(19) United States
(12) Patent Application Publication
(10) Pub. No.: US 2010/0037608 A1
(43) Pub. Date: Feb. 18, 2010

(54) Combined High Temperature Exhaust Gas and Charge Air Cooler with Protective Internal Coating

(76) Inventor: Robert F. Dierbeck, Hartford, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 12/539,981

(22) Filed: Aug. 12, 2009

Related U.S. Application Data
(60) Provisional application No. 61/088,761, filed on Aug. 14, 2008.

(51) Int. Cl. F02B 33/44; F02M 25/07

(52) U.S. Cl. 60/605.2; 123/568.12

(57) ABSTRACT

A combined diesel engine exhaust gas and charge air cooler utilizes an all-aluminum construction and a high temperature and corrosion resistant internal coating.

### CROSS REFERENCE TO RELATED APPLICATIONS

This application claims priority from U.S. Provisional Application Ser. No. 61/088,761, filed Aug. 14, 2008.

### BACKGROUND OF THE INVENTION

The recirculation of diesel engine exhaust gas has long been used to reduce pollution. In a typical diesel engine, such as may be used in an over-the-road truck, will generate exhaust gases having a temperature of up to about 1150° F. (620° C.). A portion of the exhaust gas is recirculated back into the intake manifold of the engine. The exhaust gas recirculation (EGR) system helps to control temperature of the recirculated exhaust gas to help reduce the formation of NOₓ gases. A typical diesel truck engine will have an EGR cooler to reduce the temperature of the recirculated exhaust gas and, in some instances, the system may include two EGR coolers.

An EGR cooler must be able to withstand the high temperature exhaust gas and also tolerate certain highly corrosive components of the gas, including sulfuric acid. As a result, many EGR coolers are made of stainless steel.

A turbocharged diesel engine will also have a separate charge air cooler (CAC) to reduce the temperature of the compressed air supplied to the intake manifold of the engine. Compressed air from the turbocharger is not as hot as exhaust gas, but may still attain a temperature of 400° F. (205° C.) or higher. However, conventional charge air coolers using brazed metal joints are typically not capable of handling heated turbocharged air to temperatures in excess of about 425° F. (220° C.). In some applications, charge air may be heated to 600° F. (315° C.) where brazed joints will fail completely.

FIG. 1 shows a schematic representation of a prior art turbocharged diesel engine 40 and EGR system 41. In this system, the engine exhaust gas is divided into two flows that are passed, respectively, into a first EGR cooler 42 and directly to the turbocharger 46 to drive the fan to compress combustion air to produce the charge air for the engine. The first EGR cooler 42 may typically use engine coolant to reduce the exhaust gas temperature. The exhaust gas exiting the first EGR cooler is directed by the EGR valve 43 back to the engine intake 44.

The exhaust gas, directed for recirculation by the EGR valve 43, may be at a temperature of about 500° F. (260° C.). Adjustment of the EGR valve controls the relative flow of recirculated exhaust and exhaust to the turbocharger where the latter is mixed with combustion air 19. The precooled exhaust gas is then directed to a second EGR cooler 45. A bypass valve 48 in the line downstream from the EGR valve 43 returns the precooled exhaust gas directly to the engine at low (idle) engine speeds. Simultaneously, a parallel flow of charge air from the turbocharger 46 is directed to and through a charge air cooler 47. The exit flows of exhaust gas from the second EGR cooler 45 and the charge air from the charge air cooler 47 are combined and directed to the engine intake 44.

The foregoing system requires an expensive first EGR cooler 42, requiring stainless steel or other high temperature resistant construction. The system also includes a second EGR cooler 45. In accordance with the present invention, both EGR coolers 42 and 45 may be effectively eliminated.

U.S. Pat. No. 7,422,054, which is incorporated by reference herein, describes an all-aluminum heat exchanger assembly that is particularly adapted for use as a charge air cooler. In this heat exchanger, high temperature resistance (e.g. in excess of 600° F. or 315° C.) is provided by utilizing welded joints instead of brazed joints.

### SUMMARY OF THE INVENTION

In accordance with the present invention, the all-aluminum charge air cooler is modified to also receive the EGR flow, wherein the charge air and EGR flow are cooled together in a single heat exchanger and returned to the engine intake manifold. The all-aluminum construction provides the high temperature resistance that is required and, to protect against the corrosive components of the exhaust gas, the interior portions of the heat exchanger are coated with a corrosion-resistant electroceramic coating that remains effective at high temperatures.

### BRIEF DESCRIPTION OF THE DRAWINGS

FIG. 1 is a schematic representation of a turbocharged diesel engine and exhaust gas recirculation system of the prior art.

FIG. 2 is a schematic representation of a first embodiment of a combined high temperature charge air cooler and direct EGR cooler of the present invention.

FIG. 3 is a schematic representation of a second embodiment of the present invention.

FIGS. 4 and 5 are, respectively, front and side elevation views of an all-aluminum heat exchanger in accordance with the above identified patent application that is especially adapted for use in the system of the present invention.

### DETAILED DESCRIPTION OF THE PREFERRED EMBODIMENTS

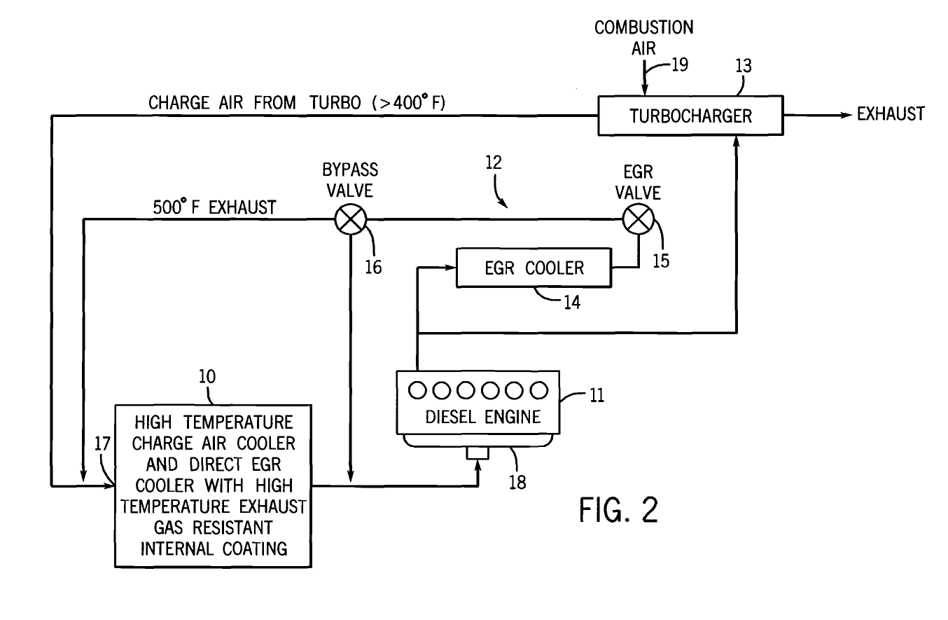

Referring to FIG. 2, a combined high temperature charge air cooler and direct EGR cooler 10 is shown in a system for a diesel engine 11. The diesel engine 11 includes an exhaust gas recirculation (EGR) system 12 and a turbocharger 13 for supplying compressed combustion air to the engine.

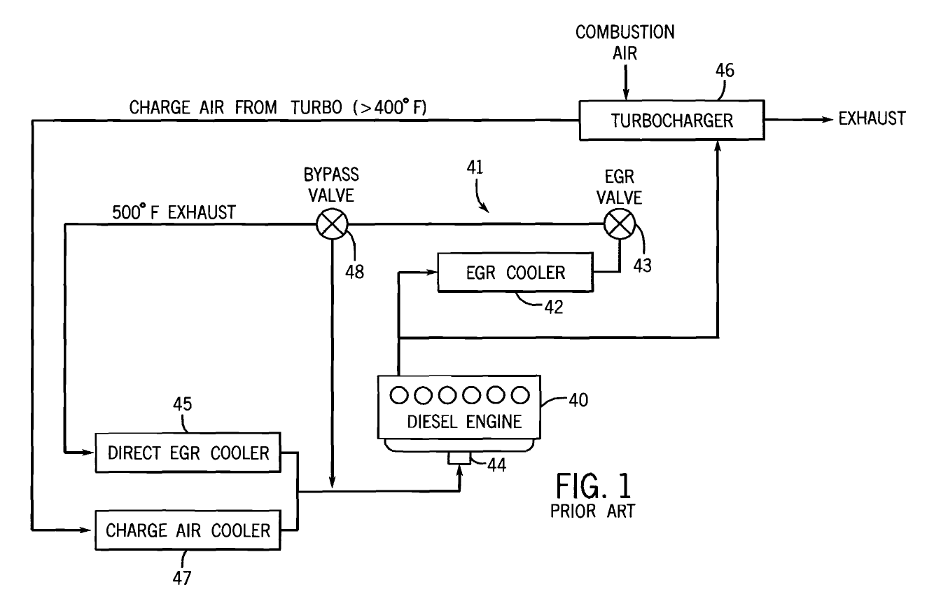

In accordance with the invention, a single combined charge air and EGR cooler 10 is used to handle both the charge air and the recirculated exhaust gas. From the engine 11, the exhaust gas is divided and a portion of the flow is directed through a conventional EGR cooler 14 which, as indicated above, may utilize engine coolant as the heat exchange medium. The exhaust gas into the EGR cooler 14 may be at about 1000° F. (540° C.) or higher and is cooled in the EGR cooler 14 to a temperature of about 500° F. (260° C.). The other portion of the exhaust from the engine is used to drive the turbocharger 13 as described with respect to the prior art system of FIG. 1. The portion of the initially cooled exhaust is passed through an EGR valve 15 where the volume of exhaust flow recirculated back to the engine 11 is controlled. A by-pass valve 16 operates at low engine speeds to redirect a portion of the flow from the EGR valve 15 directly back to the engine 11. In normal operation, however, the initially cooled exhaust gas passes directly to the inlet 17 of the combined CAC and EGR cooler 10. At the same time, the charge air from the turbocharger 13 is also directed to the inlet 17 where it is mixed and passes with the recirculated exhaust gas through the combined cooler 14 to the inlet manifold 18 of the engine 11.

There are a number of benefits that are derived directly from the use of the combined high temperature CAC and EGR cooler 10. First of all, the high temperature resistant construction of the welded all-aluminum combined cooler 10 provides an improvement over prior art brazed connection heat exchanger constructions. It also eliminates the need for a more expensive stainless steel construction from a temperature resistance standpoint. In addition, the interior passages of the combined cooler 10 are coated with a high temperature resistant coating that provides protection against the corrosive components of exhaust gas, such as sulfuric acid. One presently preferred coating is provided by Henkel Technologies as an electroceramic coating, sold under the trademark ALODINE.

In this embodiment, combined flows of exhaust gas at about 500° F. (260° C.) and charge air from the turbocharger at 400° F. (205° C.) or higher provide a combined flow to the CAC and EGR cooler 10 that is well within the temperature limits of the cooler. The charge air may comprise 60-75% by volume of the flow into the cooler 10, with 30-40% by volume of the flow being precooled exhaust gas.

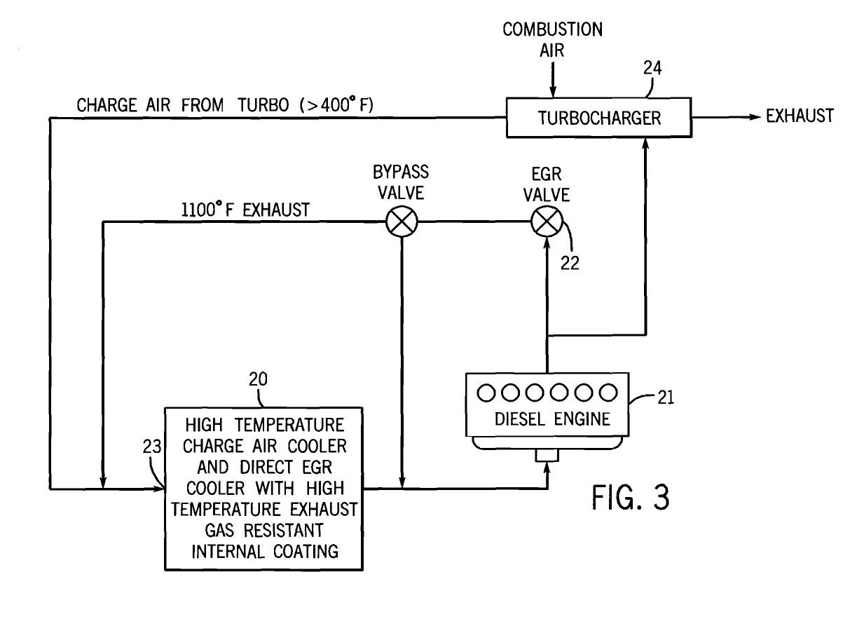

Another and presently preferred embodiment of the present invention is shown schematically in FIG. 3. In this embodiment, the combined charge air cooler and EGR cooler 20 is basically the same as the cooler 10 of the FIG. 2 embodiment. The difference in the FIG. 3 system from the FIG. 2 system is that in the FIG. 3 system there is no preliminary EGR cooler, such as the EGR cooler 14 of the FIG. 2 embodiment. Instead, a portion of the flow of high temperature engine exhaust gas from the engine 21 passes directly to the EGR valve 22 for recirculation back to the engine. The other portion of engine exhaust gas is used to drive the turbocharger 24, as described above with respect to the prior art FIG. 1 embodiment and the FIG. 2 embodiment of the invention. The high temperature exhaust gas at, for example, 1000° F. (540° C.) or higher, passes to the inlet 23 of the combined cooler 20 where it joins and is mixed with charged air from the turbocharger 24 for combined flow through the cooler 20. The combined flow of exhaust gas at 1000° F. (540° C.) and charge air at 400° F. (205° C.) or higher, results in a gas flow temperature into the cooler that is still well within the heat resistant capability of the cooler. In this embodiment, therefore, the conventional EGR precooler 14 of the FIG. 2 embodiment is eliminated. With respect to the FIG. 1 prior art embodiment, two EGR coolers are eliminated.

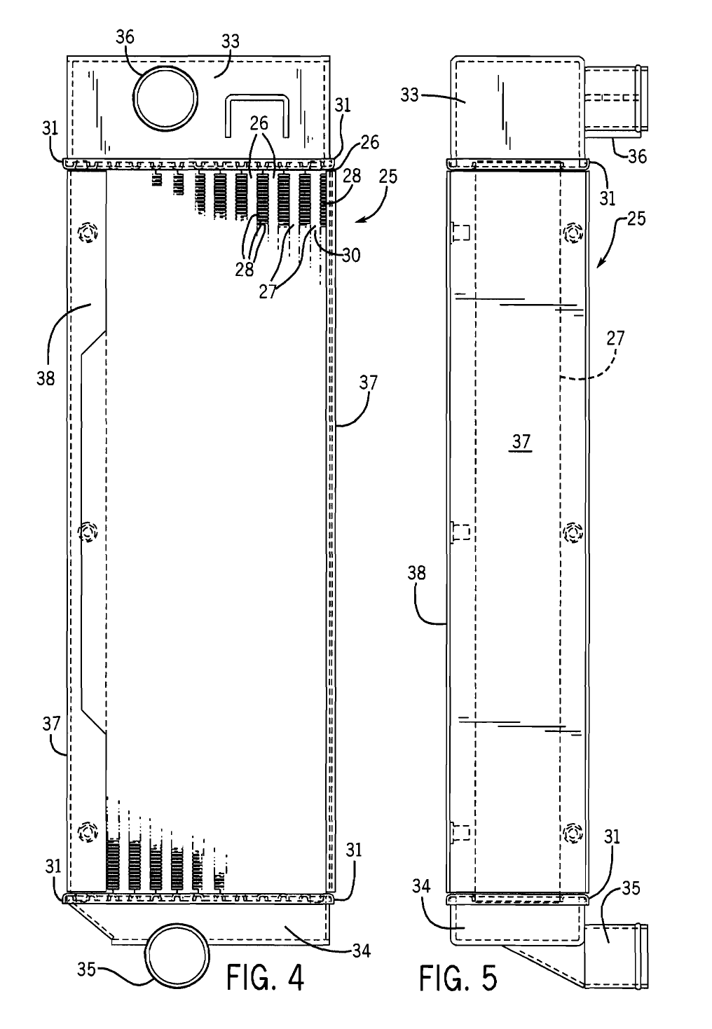

FIGS. 4 and 5 show one embodiment of a combined charge air cooler and EGR cooler 10 and 20, as shown schematically in FIGS. 2 and 3. The combined exhaust gas and charge air cooler 25 of FIGS. 4 and 5 is made of an assembly of extruded tubular aluminum modules 26, each of which includes a body 27 having toothed fins 28 formed in opposite module faces and a plurality of longitudinal through bores 30 that extend the full lengths of the modules 26. Upper and lower aluminum header plates 31 are provided with openings 32 into which the respective upper and lower ends of the modules 26 are received. The modules are attached to the header plates 31 with fluid-tight joints made by welding together substantially equal portions of module and header plate material.

An upper tank 33 is welded to a peripheral edge of the upper header plate 31 with a fluid-tight weld or fused connection. The tank and welded connection are also aluminum. An aluminum bottom tank 34 is similarly welded to the lower header plate 31. The bottom tank 34 is provided with an inlet connection 35 into which the combined flow of charged air and recirculated exhaust gas is piped. The upper tank 33 is provided with an outlet connection from which the combined gas flow leaves the cooler 25 and is directed to the engine intake manifold. The combined gas flow is air cooled in its passage through the combined cooler 25 by the cooling air flowing past the fins 28 on the module bodies 27. The extruded aluminum modules 26 at the opposite edges of the cooler assembly are covered by side plates 37. Suitable mounting brackets 38 may be attached to the side plates 37 by welding or with mechanical fasteners.

I claim:

1. A method for the combined cooling of recirculated exhaust gas and charge air in a turbocharged diesel engine comprising the steps of:
(1) providing an all-aluminum heat exchanger having a gas inlet and a gas outlet;
(2) coating interior contact surfaces of the heat exchanger with an acid-resistant coating capable of withstanding a temperature of at least 600° F. (315° C.);
(3) combining the flows of recirculated exhaust gas and charge air; and
(4) directing the combined flow from the gas inlet, through the heat exchanger and from the outlet to the engine intake.

2. The method as set forth in claim 1 comprising the additional step of directing a portion of the exhaust gas from the engine without substantial cooling through an exhaust gas recirculation valve before the combining step.

3. The method as set forth in claim 2 wherein the combining step effects a substantial reduction in the temperature of the combined flow

4. The method as set forth in claim 2 including the step of the remaining portion of the exhaust gas from the engine to the turbocharger.

5. The method as set forth in claim 1 wherein the coating step comprises electroceramic coating.

6. An exhaust gas recirculation and charge air supply system for a turbocharged diesel engine comprising:
an EGR passage for a portion of the exhaust gas from the engine to a heat exchanger;
a charge air passage from the turbocharger to the heat exchanger;
the heat exchanger having an all-aluminum construction and interior gas contact surfaces coated with an acid and high temperature resistant coating; and,
a combined exhaust gas and charge air passage from the heat exchanger to the engine intake.

7. The apparatus as set forth in claim 6 wherein the coating comprises an electroceramic coating.

8. The apparatus as set forth in claim 6 wherein the heat exchanger is operable to use ambient air as the cooling medium.

9. The apparatus as set forth in claim 6 wherein the EGR passage includes an EGR valve operative to adjustably divide the exhaust gas from the engine into a first portion directed through the valve and into the EGR passage, and a second portion directed into the turbocharger.

10. The apparatus as set forth in claim 9 including an EGR cooler for the first portion.
